(19) United States
(12) Patent Application Publication
(10) Pub. No.: US 2016/0167534 A1
(43) Pub. Date: Jun. 16, 2016

(54) CHARGING APPARATUS

(71) Applicant: TOYOTA JIDOSHA KABUSHIKI KAISHA, Toyota-shi (JP)

(72) Inventors: Takeaki SUZUKI, Susono-shi (JP); Michihiro MIYASHITA, Susono-shi (JP); Kazuhito ESHIMA, Susono-shi (JP); Hiroshi NATE, Toyota-shi (JP); Sunao HORITAKE, Toyota-shi (JP)

(73) Assignee: TOYOTA JIDOSHA KABUSHIKI KAISHA, Toyota-shi (JP)

(21) Appl. No.: 14/944,761

(22) Filed: Nov. 18, 2015

(30) Foreign Application Priority Data
Dec. 12, 2014 (JP) 2014-251901

(51) Int. Cl. B60L 11/18

(52) U.S. Cl. CPC B60L 11/1814; B60L 11/1805

(57) ABSTRACT

A charging apparatus is mounted on a vehicle having a plurality of batteries and a power generating device. The charging apparatus is provided with a controller (i) configured to obtain power accumulation ratios of the plurality of batteries, (ii) configured to determine whether or not each of obtained power accumulation ratios is in an appropriate range corresponding to each of the plurality of batteries, and (iii) configured to control the power generating device so that generated voltage of the power generating device is in an overlap range, if it is determined that power accumulation ratio of one battery of the plurality of batteries is greater than an upper limit of the appropriate range of the one of battery and if the power generating device performs the power regeneration upon deceleration of the vehicle.

### CROSS-REFERENCE TO RELATED APPLICATIONS

This application is based upon and claims the benefit of priority of the prior Japanese Patent Application No. 2014-251901, file on Dec. 12, 2014, the entire contents of which are incorporated herein by reference.

### BACKGROUND OF THE INVENTION

1. Field of the Invention

The present invention relates to a charging apparatus mounted on a vehicle such as, for example, an automobile.

2. Description of the Related Art

As this type of apparatus, for example, there is proposed an apparatus having such a configuration that a lead storage battery, a lithium storage battery, a generator, and a load are electrically connected in parallel with each other, the apparatus being provided with: a MOS-FET configured to switch between conduction and blockage between (i) the generator and the lead storage battery and (ii) the lithium storage battery and the load; and a relay electrically connected between the MOS-FET and the lithium storage battery, the relay configured to switch between conduction and blockage with respect to the lithium storage battery, wherein operating states of the MOS-FET and the relay and set voltage of a regulator are controlled so that a state of charge (SOC) of the lead storage battery and a SOC of the lithium storage battery are both in respective appropriate ranges (refer to Japanese Patent Application Laid Open No. 2011-176958).

Alternatively, there is also proposed an apparatus in which a lead storage battery and a lithium storage battery are electrically connected in parallel, wherein the lithium storage battery is set in such a manner that there is a point at which open voltage of the lead storage battery matches open voltage of the lithium storage battery in a SOC use range of the lead storage battery and in a SOC use range of the lithium storage battery (refer to Japanese Patent Application Laid Open No. 2011-178384).

Alternatively, there is also proposed an apparatus in which a high-output battery with a low internal resistance and a low capacity and a high-capacity battery with a higher internal resistance than that of the high-output battery and a higher capacity than that of the high-output battery are connected in parallel, wherein a reduction tendency of open circuit voltage with respect to a SOC reduction associated with the high-output battery is greater than a reduction tendency of open circuit voltage with respect to a SOC reduction associated with the high-capacity battery (refer to Japanese Patent Application Laid Open No. 2007-122882).

In the technology described in Japanese Patent Application Laid Open No. 2011-176958, when the MOS-FET is in a cutoff state, if a load (or an electrical device) that requires power supply from two storage batteries for stable operation, such as, for example, an electric active stabilizer, is operated, there is a possibility that the load is not appropriately operated because the power supply is performed only from the lithium storage battery, which is technically problematic. In the technologies described in Japanese Patent Application Laid Open No. 2011-178384 and Japanese Patent Application Laid Open No. 2007-122882, the technical problem cannot be solved.

### SUMMARY OF THE INVENTION

In view of the technical problems according to the present invention, it is therefore an object of the present invention to provide a charging apparatus configured to appropriately operate the load even if there is the load that requires the stable operation.

The above object of the present invention can be achieved by a charging apparatus mounted on a vehicle having a plurality of batteries, and a power generating device, which can supply power to each of the plurality of batteries and can perform power regeneration for converting kinetic energy to electrical energy, said charging apparatus is provided with: a controller (i) configured to obtain power accumulation ratios, each of which is a ratio of a charge accumulating amount to an entire capacity, of the plurality of batteries, (ii) configured to determine whether or not each of the obtained power accumulation ratios is in an appropriate range corresponding to each of the plurality of batteries, and (iii) configured to control the power generating device so that generated voltage of the power generating device is in an overlap range in which open circuit voltage ranges respectively corresponding to appropriate ranges of the plurality of batteries are overlapped, if it is determined that power accumulation ratio of one battery of the plurality of batteries is greater than an upper limit of an appropriate range of the one of battery and if the power generating device performs the power regeneration upon deceleration of the vehicle.

According to the charging apparatus of the present invention, the charging apparatus is mounted on the vehicle that is provided with the plurality of batteries and the power generating device. The power generating device is configured to perform the power regeneration for converting the kinetic energy to the electrical energy. The kinetic energy may be, for example, a driving force of an engine, or may be a rotational force of drive wheels.

The charging apparatus is provided with the controller.

The controller, which is provided, for example, with a memory, a processor, a comparator, or the like, obtains the power accumulation ratios (e.g. SOCs) of the plurality of batteries. The controller determines whether or not the each of obtained power accumulation ratios is in an appropriate range corresponding to each of the plurality of batteries. Here, the appropriate range means a power accumulation ratio range in which the battery is not overcharged or overdischarged (i.e. a usable SOC range).

The controller controls the power generating device so that the generated voltage of the power generating device is in an overlap range in which open circuit voltage ranges respectively corresponding to appropriate ranges of the plurality of batteries are overlapped, if it is determined that the power accumulation ratio of one battery of the plurality of batteries is not in the appropriate range of the one battery.

The open circuit voltage range corresponding to the appropriate range means open circuit voltage range between open circuit voltage corresponding to a lower limit value of the appropriate range of the power accumulation ratio and open circuit voltage corresponding to an upper limit value of the appropriate range of the power accumulation ratio, on a voltage characteristic line indicating a relation between the power accumulation ratio of a battery and the open circuit voltage of the battery. The overlap range means an overlap range between open circuit voltage range corresponding to the appropriate range of one battery and open circuit voltage range corresponding to the appropriate range of another battery.

If the power accumulation ratio of the battery increases, the open circuit voltage of the battery also increases. In other words, the voltage characteristic line indicating the relation between the power accumulation ratio of the battery and the open circuit voltage of the battery is a monotonically increasing graph.

Therefore, in a case where the power accumulation ratio of the one battery exceeds an upper limit value of the appropriate range of the one battery, if the generated voltage of the power generating device is the open circuit voltage corresponding to the appropriate range of the one battery, the one battery is discharged because the generated voltage is less than open circuit voltage corresponding to a present power accumulation ratio of the one battery.

On the other hand, for example, in a case where the power accumulation ratio of the one battery falls below a lower limit value of the appropriate range of the one battery, if the generated voltage of the power generating device is the open circuit voltage corresponding to the appropriate range of the one battery, the one battery is charged because the generated voltage is greater than the open circuit voltage corresponding to the present power accumulation ratio of the one battery.

Here, according to the study of the present inventors, the following is found; namely, for example, if the battery and a load or a generator are electrically connected or disconnected during driving of the vehicle in order to maintain the power accumulation ratio of the battery in the appropriate range, then, a load that requires voltage stabilization, such as an electric active stabilizer, is possibly not appropriately operated.

In the present invention, as described above, the controller controls the generated voltage of the power generating device, by which the power accumulation ratio of the battery is controlled. In other words, in the present invention, the battery does not need to be electrically disconnected from the load and the generator in order to maintain the power accumulation ratio of the battery in the appropriate range. According to the charging apparatus of the present invention, even if there is the load that requires the stable operation, the load can be supplied with required electric power, and the load can be appropriately operated.

Particularly in the present invention, if it is determined that the power accumulation ratio of one battery of the plurality of batteries is greater than the upper limit of the appropriate range of the one battery and if the power generating device performs the power regeneration upon deceleration of the vehicle, the power generating device is controlled by the controller so that the generated voltage of the power generating device is in the overlap range.

Upon deceleration of the vehicle, in order to improve fuel efficiency, it is important to set as high generated voltage of the power generating device as possible, and to actively collect electric power by the power regeneration (i.e. to charge the battery). If, however, the power accumulation ratio of the one battery is greater than the upper limit of the appropriate range of the one battery, the one battery is possibly overcharged.

Thus, in this aspect, the power generating device is controlled by the controller so that the generated voltage of the power generating device is in the overlap range. As a result, the generated voltage becomes less than the open circuit voltage corresponding to the present power accumulation ratio of the one battery, and the one battery is discharged. It is therefore possible to prevent that the one battery is overcharged.

In one aspect of the charging apparatus according to the present invention, said controller further configured to control the power generating device so that the generated voltage is in the overlap range, if it is determined that the power accumulation ratio of the one battery is less than a lower limit of the appropriate range of the one of battery and if the power generating device does not perform the power regeneration.

Here, “if the power regeneration is not performed” means other than upon deceleration of the vehicle, such as upon acceleration and upon constant speed running of the vehicle. In this case, in order to improve the fuel efficiency, it is important to suppress the generated voltage of the power generating device to be relatively low. If, however, the power accumulation ratio of the one battery is less than the lower limit of the appropriate range of the one battery, the one battery is possibly overdischarged.

Thus, in this aspect, the power generating device is controlled by the controller so that the generated voltage of the power generating device is in the overlap range. As a result, the generated voltage becomes greater than the open circuit voltage corresponding to the present power accumulation ratio of the one battery, and the one battery is charged. It is therefore possible to prevent that the one battery is overdischarged.

In another aspect of the present invention, the plurality of batteries include a lead battery, and a nickel hydrogen battery or a lithium ion battery, and the vehicle has a high-output load, which is a load supplied with electric power from both the lead battery and the nickel hydrogen battery or the lithium ion battery in operation.

According to the charging apparatus of the present invention, as described above, the high-output load mounted on the vehicle can be appropriately operated.

The nature, utility, and further features of this invention will be more clearly apparent from the following detailed description with reference to a preferred embodiment of the invention when read in conjunction with the accompanying drawings briefly described below.

### BRIEF DESCRIPTION OF THE DRAWINGS

FIG. 1 is a schematic configuration diagram illustrating an outline of a charging apparatus according to an embodiment;

FIG. 2 is a diagram illustrating one example of respective voltage characteristic lines of a lead battery and a nickel hydrogen battery;

FIG. 3 is a diagram illustrating one example of generated voltage defined by a SOC of the lead battery and a SOC of the nickel hydrogen battery;

FIG. 4 is a flowchart illustrating a charge control process according to the embodiment;

FIG. 5 is a time chart illustrating one example of time variations of the SOC and current of the battery, and generated voltage of a generator; and

FIG. 6 is a diagram illustrating one example of respective voltage characteristic lines of the lead battery, the nickel hydrogen battery, and a lithium ion battery.

### DETAILED DESCRIPTION OF THE PREFERRED EMBODIMENT

### Embodiment of the Invention

A charging apparatus according to an embodiment of the present invention will be explained on the basis of the drawings.

### (Configuration of Charging Apparatus)

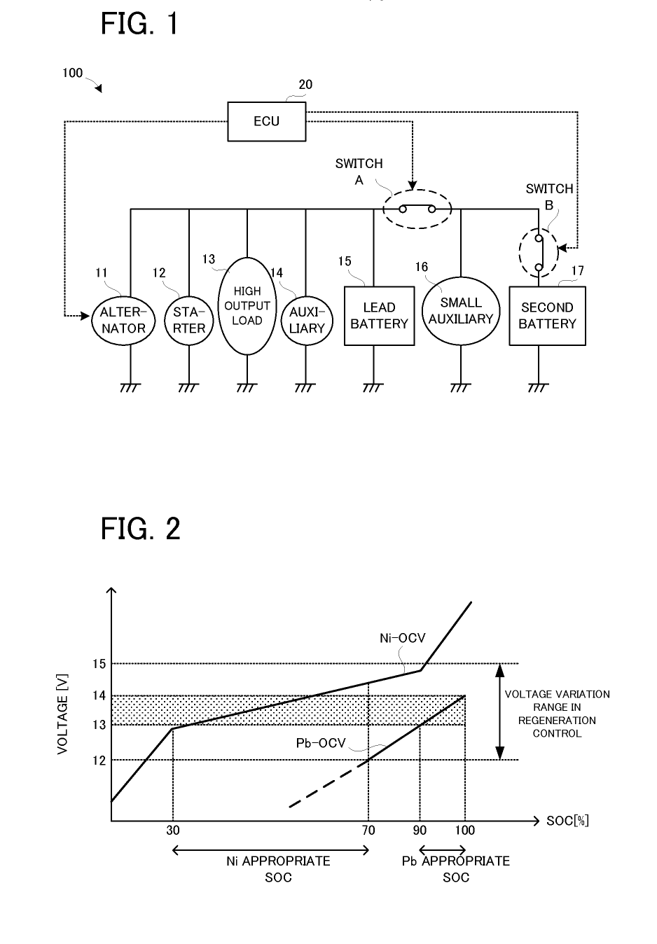

A configuration of the charging apparatus according to the embodiment will be explained with reference to FIG. 1. FIG. 1 is a schematic configuration diagram illustrating an outline of the charging apparatus according to the embodiment.

In FIG. 1, a vehicle on which a charging apparatus 100 is mounted is provided with an alternator 11, a starter motor 12, a high-output load 13, an auxiliary 14, a lead battery 15, a small auxiliary 16, a second battery 17, and an electronic control unit (ECU) 20. In the embodiment, the second battery 17 is assumed to be a nickel hydrogen battery.

The alternator 11 performs power regeneration for converting kinetic energy to electrical energy, by being driven, for example, by an engine (not illustrated), or by transmitting rotation of drive wheels (not illustrated) upon deceleration of the vehicle. An electric power of the power regeneration is also used to charge the lead battery 15 and the second battery 17. The alternator 11 may also have a function of the starter motor 12.

The high-output load 13 means a load in which voltage stabilization is required (specifically, an electric power is supplied from both the lead battery 15 and the second battery 17 in operation) for stable operation, such as, for example, an electric active stabilizer, an electric power steering apparatus, an electronic control suspension, and an electric control brake.

The second battery 17 and the alternator 11 or the lead battery 15 are electrically connected via a switch A and a switch B. The switch A and the switch B are controlled by the ECU 20.

For example, if the second battery 17 deteriorates, the switch B is set in an OFF state (while the switch A is in an ON state). Alternatively, if the lead battery 15 fails, the switch A is set in the OFF state and the switch B is set in the ON state, and the second battery 17 functions as a backup power supply of the small auxiliary 16. The embodiment is premised on that there is no failure of the lead battery 15 and no deterioration of the second battery 17. Thus, hereinafter, an explanation will be given on the premise that the switch A and the switch B are both in the ON state. In other words, during normal running of the vehicle, the switch A and the switch B are both in the ON state.

The charging apparatus 100 according to the embodiment is provided with the

ECU 20. In other words, in the embodiment, a partial function of the ECU 20 configured to perform various electronic control of the vehicle is used as a part of the charging apparatus 100.

### (Charge Control Process)

Next, a charge control process performed by the charging apparatus 100 mainly during running of the vehicle will be explained.

The ECU 20 as a part of the charging apparatus 100 obtains a SOC associated with the lead batter 15 and a SOC associated with the second battery 17. Since various known aspects can be applied to a method of obtaining the SOC, the details of the method will be omitted. The “SOC” according to the embodiment is one example of the “power accumulation ratio” according to the present invention.

The ECU 20 determines whether or not the SOC of the lead battery 15 and the SOC of the second battery 17 are in respective appropriate ranges of the SOC (hereinafter referred to as “appropriate SOC ranges” as occasion demands). The appropriate SOC range is set, as occasion demands, for example, according to specification of the battery or the like. In the embodiment, as illustrated in FIG. 2, for the lead battery 15, SOC 90% to 100% is the appropriate SOC range, and for the second battery 17, SOC 30% to 70% is the appropriate SOC range.

The ECU 20 controls generated voltage of the alternator 11 if it is determined that at least one of the SOC of the lead battery 15 and the SOC of the second battery 17 is out of the appropriate SOC range of at least one of the batteries.

Specifically, the ECU 20 controls the alternator 11 so that the generated voltage of the alternator 11 is in an overlap range (or “13 V to 14 V” here; refer to a hatched range in FIG. 2) between open circuit voltage range corresponding to the appropriate SOC range of the lead battery 15 (or “13 V to 14 V” here; refer to “Pb-OCV” in FIG. 2) and open circuit voltage range corresponding to the appropriate SOC range of the second battery 17 (or “12.8 V to 14.3 V” here; refer to “Ni-OCV” in FIG. 2).

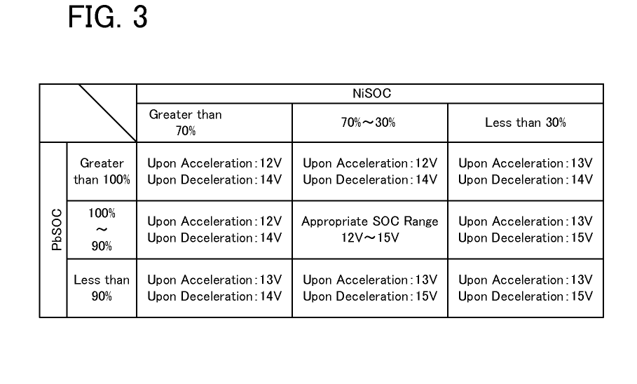

More specifically, the ECU 20 controls the alternator 11 to have the generated voltage illustrated in FIG. 3 according to the SOC of the lead battery 15, the SOC of the second battery 17, and a running state of the vehicle.

Specifically, if the SOC of the lead battery 15 is greater than 100%, i.e. if the SOC of the lead battery 15 is greater than an upper limit of the appropriate SOC range of the lead battery 15, there is a possibility that the lead battery 15 is overcharged. Thus, if the SOC of the lead battery 15 is greater than 100%, the ECU 20 sets the generated voltage of the alternator 11 to 14V upon deceleration of the vehicle (refer to a row of “PbSOC: greater than 100%” in FIG. 3).

14V is less than the open circuit voltage when the SOC of the lead battery 15 is greater than 100% (refer to FIG. 2). Thus, if the generated voltage of the alternator 11 is 14V, the lead battery 15 is discharged, and the SOC of the lead battery 15 decreases. As a result, it is prevented that the lead battery 15 is overcharged. On the other hand, since the open circuit voltage corresponding to the SOC 100% of the lead battery 15 is 14V (refer to FIG. 2), the SOC of the lead battery 15 is maintained in the vicinity of 100%. At least one portion of the electric power generated by the alternator 11 is directly supplied to the high-output load 13, the auxiliary 14, or the like.

If the SOC of the lead battery 15 is less than 90%, i.e. if the SOC of the lead battery 15 is lower than a lower limit of the appropriate SOC range of the lead battery 15, there is a possibility that the lead battery 15 is overdischarged. Thus, if the SOC of the lead battery 15 is less than 90%, the ECU 20 sets the generated voltage of the alternator 11 to 13V upon acceleration of the vehicle (refer to a row of “PbSOC: less than 90%” in FIG. 3).

13V is greater than the open circuit voltage when the SOC of the lead battery 15 is less than 90% (refer to FIG. 2). Thus, if the generated voltage of the alternator 11 is 13V, the lead battery 15 is charged, and the SOC of the lead battery 15 increases. As a result, it is prevented that the lead battery 15 is overdischarged.

On the other hand, from the viewpoint of fuel efficiency, the generated voltage of the alternator 11 upon acceleration of the vehicle is desirably as low as possible. Since 13V is the open circuit voltage corresponding to the SOC 90% of the lead battery 15, it is possible to suppress a reduction in fuel efficiency caused by the charge control process.

If the SOC of the second battery 17 is greater than 70%, i.e. if the SOC of the second battery 17 is greater than an upper limit of the appropriate SOC range of the second battery 17, there is a possibility that the second battery 17 is overcharged. Thus, if the SOC of the second battery 17 is greater than 70%, the ECU 20 sets the generated voltage of the alternator 11 to 14V upon deceleration of the vehicle (refer to a row of “NiSOC: greater than 70%” in FIG. 3).

14V is less than the open circuit voltage when the SOC of the second battery 17 is greater than 70% (refer to FIG. 2). Thus, if the generated voltage of the alternator 11 is 14V, the second battery 17 is discharged, and the SOC of the second battery 17 decreases. As a result, it is prevented that the second battery 17 is overcharged. On the other hand, since the open circuit voltage corresponding to the SOC 70% of the second battery 17 is 14V (refer to FIG. 2), the SOC of the second battery 17 is maintained in the vicinity of 70%.

If the SOC of the second battery 17 is less than 30%, i.e. if the SOC of second battery 17 is lower than a lower limit of the appropriate SOC range of the second battery 17, there is a possibility that the second battery 17 is overdischarged. Thus, if the SOC of the second battery 17 is less than 30%, the ECU 20 sets the generated voltage of the alternator 11 to 13V upon acceleration of the vehicle (refer to a row of “NiSOC: less than 30%” in FIG. 3).

13V is greater than the open circuit voltage when the SOC of the second battery 17 is less than 30% (refer to FIG. 2). Thus, if the generated voltage of the alternator 11 is 13V, the second battery 17 is charged, and the SOC of the second battery 17 increases. As a result, it is prevented that the second battery 17 is overdischarged.

On the other hand, from the viewpoint of fuel efficiency, the generated voltage of the alternator 11 upon acceleration of the vehicle is desirably as low as possible. Since 13V is the open circuit voltage corresponding to the SOC 30% of the second battery 17, it is possible to suppress a reduction in fuel efficiency caused by the charge control process.

If the SOC of the lead battery 15 and the SOC of the second battery 17 are both in the respective appropriate SOC ranges, the ECU 20 sets the generated voltage in a range of the generated voltage of the alternator 11 set in advance (or “12V to 15V” herein).

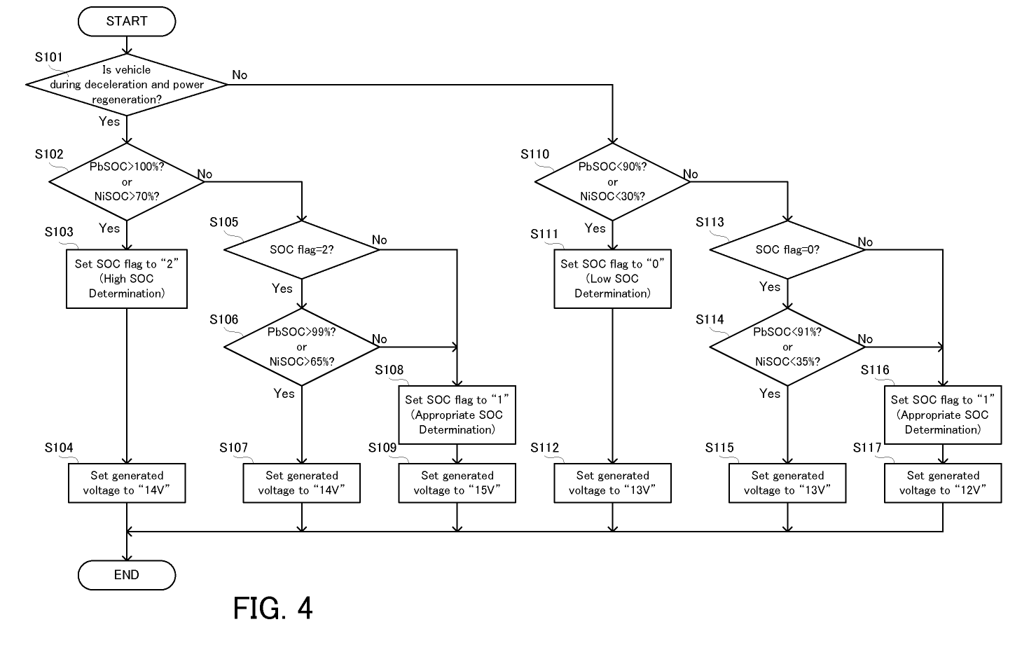

Next, the aforementioned charge control process will be explained with reference to a flowchart in FIG. 4.

In FIG. 4, the ECU 20 as a part of the charging apparatus 100 firstly determines whether or not the vehicle is decelerating and the alternator 11 performs power regeneration (hereinafter referred to as “during deceleration and power regeneration” as occasion demands) (step S101). Since various known aspects can be applied to the determination of whether or not the vehicle is during deceleration and power regeneration, the details of the determination will be omitted.

If it is determined that the vehicle is during deceleration and power regeneration (the step S101: Yes), the ECU 20 determines whether or not the SOC of the lead battery 15 is greater than 100%, or whether or not the SOC of the second battery 17 is greater than 70% (step S102).

If it is determined that the SOC of the lead battery 15 is greater than 100%, or that the SOC of the second battery 17 is greater than 70% (the step S102: Yes), the ECU 20 controls the alternator 11 so that the generated voltage of the alternator 11 is 14V (step S104).

In the process of the step S102, if it is determined that the SOC of the lead battery 15 is less than or equal to 100%, and that the SOC of the second battery 17 is less than or equal to 70% (the step S102: No), the ECU 20 determines whether or not a value of a SOC flag is “2” (step S105).

If it is determined that the value of the SOC flag is “2” (the step S105: Yes), the ECU 20 determines whether or not the SOC of the lead battery 15 is greater than 99%, or whether or not the SOC of the second battery 17 is greater than 65% (step S106).

If it is determined that the SOC of the lead battery 15 is greater than 99%, or that the SOC of the second battery 17 is greater than 65% (the step S106: Yes), the ECU 20 controls the alternator 11 so that the generated voltage of the alternator 11 is 14V (step S107).

The case where the value of the SOC flag is “2” is a case where at least one of the SOC of the lead battery 15 and the SOC of the second battery 17 is greater than (or was greater than) the upper limit of the appropriate SOC range. Thus, the generated voltage of the alternator 11 is set to 14V (refer to the step S103 and the step S104 described above). At this time, if the generated voltage of the alternator 11 is changed (or increased from 14V to 15V herein) immediately on condition that the SOC of the lead battery 15 and the SOC of the second battery 17 are both in the respective appropriate SOC ranges, there is a possibility that the at least one of the SOC is greater than the upper limit of the appropriate SOC range again. Thus, by performing the processes in the step S105 to the step S107 described above, hysteresis characteristics are provided for the charge control process.

In the process in the step S105 described above, if it is determined that the value of the SOC flag is not “2” (the step S105: No), or in the process in the step S106 described above, if it is determined that the SOC of the lead battery 15 is less than or equal to 99%, and that the SOC of the second battery 17 is less than or equal to 65% (the step S106: No), the ECU 20 sets the value of the SOC flag to “1” (step S108).

The ECU 20 then controls the alternator 11 so that the generated voltage of the alternator 11 is 15V (step S109).

In the process in the step S101 described above, if it is determined that the vehicle is not during deceleration and power regeneration (the step S101: No), the ECU 20 determines whether or not the SOC of the lead battery 15 is less than 90%, or whether or not the SOC of the second battery 17 is less than 30% (step S110).

If it is determined that the SOC of the lead battery 15 is less than 90%, or that the SOC of the second battery 17 is less than 30% (the step S110: Yes), the ECU 20 sets the value of the SOC flag to “0” (step S111). The ECU 20 then controls the alternator 11 so that the generated voltage of the alternator 11 is 13V (step S112).

In the process in the step S110 described above, if it is determined that the SOC of the lead battery 15 is greater than or equal to 90%, and that the SOC of the second battery 17 is greater than or equal to 30% (the step S110: No), the ECU 20 determines whether or not the value of the SOC flag to “0” (step S113).

If it is determined that the value of the SOC flag to “0” (the step S113: Yes), the ECU 20 determines whether or not the SOC of the lead battery 15 is less than 91%, or whether or not the SOC of the second battery 17 is less than 35% (step S114).

If it is determined that the SOC of the lead battery 15 is less than 91%, or that the SOC of the second battery 17 is less than 35% (the step S114: Yes), the ECU 20 controls the alternator 11 so that the generated voltage of the alternator 11 is 13V (step S115).

The case where the value of the SOC flag is “0” is a case where at least one of the SOC of the lead battery 15 and the SOC of the second battery 17 is less than (or was less than) the lower limit of the appropriate SOC range. Thus, the generated voltage of the alternator 11 is set to 13V (refer to the step S111 and the step S112 described above). At this time, if the generated voltage of the alternator 11 is changed (or reduced from 13V to 12V herein) immediately on condition that the SOC of the lead battery 15 and the SOC of the second battery 17 are both in the respective appropriate SOC ranges, there is a possibility that the at least one of the SOC is less than the lower limit of the appropriate SOC range again. Thus, by performing the processes in the step S113 to the step S115 described above, the hysteresis characteristics are provided for the charge control process.

In the process in the step S113 described above, if it is determined that the value of the SOC flag is not “0” (the step S113: No), or in the process in the step S114 described above, if it is determined that the SOC of the lead battery 15 is greater than or equal to 91%, or that the SOC of the second battery 17 is greater than or equal to 35% (the step S114: No), the ECU 20 sets the value of the SOC flag to “1” (step S116).

The ECU 20 then controls the alternator 11 so that the generated voltage of the alternator 11 is 12V (step S117).

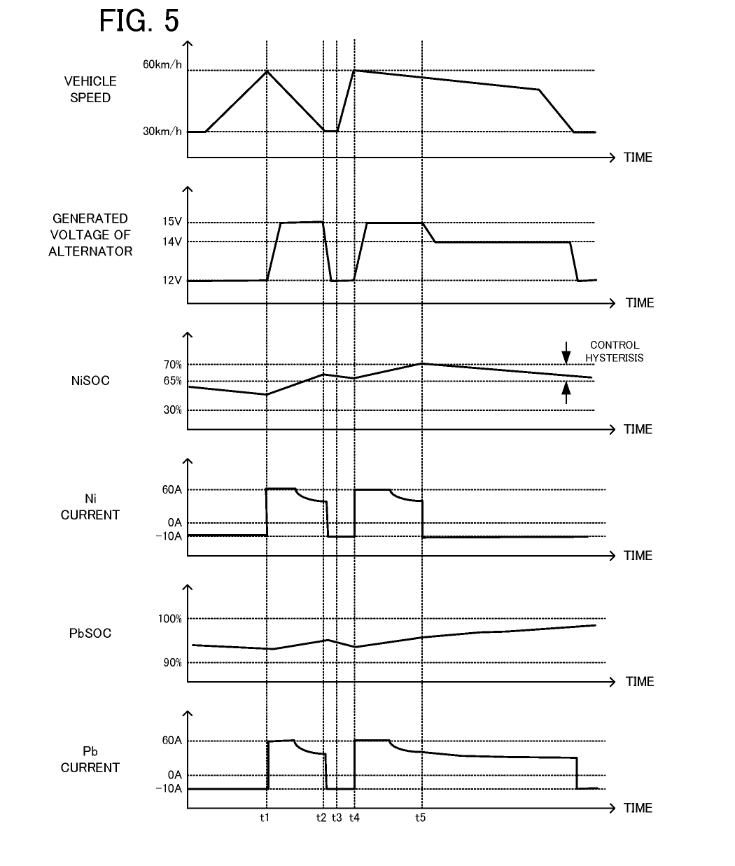

Next, a specific case of the charge control process will be explained with reference to a time chart in FIG. 5.

At a time point t1 in FIG. 5, the vehicle starts to decelerate, in association with which the generated voltage of the alternator 11 increases (refer to “vehicle speed” and “generated voltage of alternator”). At this time, since the SOC of the lead battery 15 and the SOC of the second battery 17 are both in the respective appropriate SOC ranges (refer to “PbSOC” and “NiSOC”), the ECU 20 determines whether or not the value of the SOC flag is “2” (refer to the steps S101, S102, and S105 in FIG. 4).

Here, the value of the SOC flag is not “2”, and the ECU 20 thus controls the alternator 11 so that the generated voltage of the alternator 11 is 15V (refer to time points t1 to t2 in FIG. 5, the steps S105, S108, and S109 in FIG. 4).

If the vehicle starts to accelerate at a time point t3 in FIG. 5, the SOC of the lead battery 15 and the SOC of the second battery 17 are both in the respective appropriate SOC ranges. The ECU 20 thus determines whether or not the value of the SOC flag is “0” (refer to the steps S101, S110, and S113 in FIG. 4).

Here, the value of the SOC flag is not “0”, and the ECU 20 thus controls the alternator 11 so that the generated voltage of the alternator 11 is 12V (refer to time points t3 to t4 in FIG. 5, the steps S113, S116, and S117 in FIG. 4).

If the vehicle starts to decelerate again at a time point t4 in FIG. 5, the SOC of the lead battery 15 and the SOC of the second battery 17 are both in the respective appropriate SOC ranges, and the SOC of the SOC flag is not “2”. The ECU 20 thus controls the alternator 11 so that the generated voltage of the alternator 11 is 15V (refer to time points t4 to t5 in FIG. 5).

If the SOC of the second battery 17 becomes greater than 70% at a time point t5 by charging the second battery 17 between the time points t4 and t5 in FIG. 5 (refer to “NiSOC”), the ECU 20 sets the value of the SOC flag to “2” and controls the alternator 11 so that the generated voltage of the alternator 11 is 14V (refer to the steps S101, S102, S103, and S104 in FIG. 4).

As a result, the generated voltage becomes less than the open circuit voltage corresponding to the present SOC of the second battery 17, and the second battery 17 thus starts to be discharged (refer to “NiSOC” and “Ni”). On the other hand, the generated voltage is greater than the open circuit voltage corresponding to the present SOC of the lead battery 15, and the lead battery 15 thus keeps being charged (refer to “PbSCO” and “Pb”).

During a deceleration period of the vehicle after the time point t5, the value of the SOC flag is “2”, and the SOC of the second battery 17 is greater than 65%. The ECU 20 thus maintains the generated voltage at 14V (refer to the steps S101, S102, S105, S106, and S107 in FIG. 4).

On the charging apparatus 100 according to the embodiment, particularly when the SOC of the second battery 17 is adjusted, the second battery 17 does not need to be electrically disconnected from the alternator 11 and the lead battery 15. In other words, the charging apparatus 100 can adjust the SOC of the second battery 17 while the second battery 17 is electrically connected to, for example, the alternator 11 and the lead battery 15, and further to various loads.

Therefore, even if the high-output load 13, which requires the voltage stabilization for the stable operation (i.e. which requires power supply from the lead battery 15 and the second battery 17), is mounted on the vehicle, the high-output load 13 can be appropriately operated. In other words, the charging apparatus 100 ensures the stable operation of the high-output load 13 and contributes to ensure marketability of the high-output load 13.

The “ECU 20” according to the embodiment is one example of the “determining device” and the “controlling device” according to the present invention. The “alternator 11” according to the embodiment is one example of the “power generating device” according to the present invention.

In the embodiment, the charge control process regarding a two-battery system provided with the lead battery 15 and the second battery 17 is explained. The present invention can be also applied to a system provided with three or more batteries.

### Modified Example

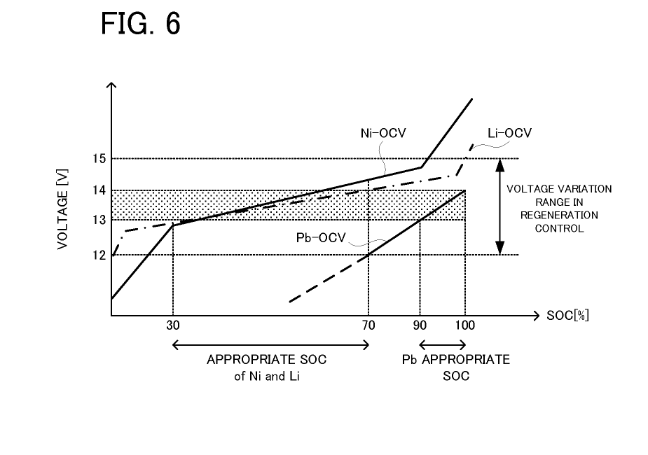

Next, a modified example of the charging apparatus 100 according to the embodiment will be explained with reference to FIG. 6. FIG. 6 is a diagram illustrating one example of respective voltage characteristic lines of the lead battery, the nickel hydrogen battery, and a lithium ion battery.

In the described above, the second battery 17 (refer to FIG. 1) is the nickel hydrogen battery. Even if the second battery 17 is a lithium ion battery, the charge control process according to the embodiment described above can be applied.

For example, as illustrated in FIG. 6, an appropriate SOC range of the lithium ion battery is SOC 30% to 70%. Open circuit voltage range corresponding to the appropriate SOC range of the lithium ion battery is 12.8V to 14V (refer to “Li-OCV” in FIG. 6). Therefore, an overlap range between the open circuit voltage range corresponding to the appropriate SOC range of the lead battery 15 and the open circuit voltage range corresponding to the appropriate SOC range of the lithium ion battery is 13V to 14V.

The invention may be embodied in other specific forms without departing from the spirit or essential characteristics thereof. The present embodiments and examples are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A charging apparatus mounted on a vehicle having a plurality of batteries, and a power generating device, which can supply power to each of the plurality of batteries, and which can perform power regeneration for converting kinetic energy to electrical energy, said charging apparatus comprising:
a controller (i) configured to obtain power accumulation ratios, each of which is a ratio of a charge accumulating amount to an entire capacity, of the plurality of batteries, (ii) configured to determine whether or not each of the obtained power accumulation ratios is in an appropriate range corresponding to each of the plurality of batteries, and (iii) configured to control the power generating device so that generated voltage of the power generating device is in an overlap range in which open circuit voltage ranges respectively corresponding to appropriate ranges of the plurality of batteries are overlapped, if it is determined that power accumulation ratio of one battery of the plurality of batteries is greater than an upper limit of an appropriate range of the one of battery and if the power generating device performs the power regeneration upon deceleration of the vehicle.

2. The charging apparatus according to claim 1, wherein said controller further configured to control the power generating device so that the generated voltage is in the overlap range, if it is determined that the power accumulation ratio of the one battery is less than a lower limit of the appropriate range of the one of battery and if the power generating device does not perform the power regeneration.

3. The charging apparatus according to claim 1, wherein
the plurality of batteries include a lead battery, and a nickel hydrogen battery or a lithium ion battery, and
the vehicle has a high-output load, which is a load supplied with electric power from both the lead battery and the nickel hydrogen battery or the lithium ion battery in operation.

4. The charging apparatus according to claim 2, wherein
the plurality of batteries include a lead battery, and a nickel hydrogen battery or a lithium ion battery, and
the vehicle has a high-output load, which is a load supplied with electric power from both the lead battery and the nickel hydrogen battery or the lithium ion battery in operation.
